(19) United States
(12) Patent Application Publication
(10) Pub. No.: US 2003/0126251 A1
(43) Pub. Date: Jul. 3, 2003

(54) Automatic network management system

(75) Inventors: Ming-Huang Chen, Taipei (TW); Sheng-Chang Chang, Taipei (TW); Yu-Lung Hsieh, Taipei (TW)

Correspondence Address: EDWARDS & ANGELL, LLP, P.O. BOX 9169, BOSTON, MA, 02209, US

(73) Assignee: Inventec Corporation

(21) Appl. No.: 10/153,950

(22) Filed: May 23, 2002

(30) Foreign Application Priority Data
Dec. 28, 2001 (TW) 90132699

(51) Int. Cl. G06F 15/173

(52) U.S. Cl. 709/223

(57) ABSTRACT

An automatic network monitor system is proposed, including a management center and a database system. The management center is at least provided with a host that is installed with management software, allowing the management center to be connected to at least an apparatus via a network. The management system is capable of automatically reading data from the apparatus periodically, and the read data are stored in the database system. By assessing the data with corresponding management rules defined in the management software, the management center is adapted to send a warming signal or to perform a maintenance control process for managing the apparatus in real time. The data stored in the database system can be utilized as reference for subsequent inquiry, statistics, analysis and maintenance.

### FIELD OF THE INVENTION

The present invention relates to automatic network management systems, and more particularly, to a network management system that can automatically detect malfunctioning of an apparatus operationally associated with a network, for allowing the apparatus to be promptly restored to proper operation.

### BACKGROUND OF THE INVENTION

By a conventional network monitor system an administrator needs to manually test operating statuses of apparatuses connected to a network periodically (e.g. two hours). For example, the administrator manually sends electronic mails to test if a mail server works properly; the administrator manually executes tool software to test functionality of apparatuses, such as a router, hub, UPS (uninterruptible power supply), various servers, etc; and, the administrator needs to dial for testing a web phone.

Therefore, when an apparatus functions improperly, the administrator would not be able to immediately realize and solve the malfunctioning problem. Furthermore, as the above monitor system operates in a manual mode for continuously monitoring apparatus performances, when the administrator is busy with working affairs, he/she may not possibly well control operating statuses for all apparatuses.

Therefore, in order to solve the above drawbacks of the conventional network monitor system, the present invention proposes an automatic network management system for more efficiently managing apparatuses associated with a network, whereby malfunctioning of an apparatus would be automatically detected and informed to an administrator who can promptly solve the malfunctioning problem or perform a maintenance control process for restoring the apparatus to proper operation.

### SUMMARY OF THE INVENTION

A primary objective of the present invention is to provide an automatic network management system for automatically managing every apparatus connected to a network, whereby when an apparatus functions improperly, the management system would automatically inform an administrator to immediately solve the malfunctioning problem or perform a maintenance control process for restoring the apparatus to proper operation.

In accordance with the above and other objectives, the present invention proposes an automatic network management system, comprising a management center and a database system. The management center is at least provided with a host that is installed with manager software, allowing the management center to be connected to at least an apparatus via a network. The management system is capable of automatically reading data from the apparatus periodically, and the read data are stored in the database system. By assessing the data with corresponding management rules defined in the manager software, the management center is adapted to send a warming signal or to perform a maintenance control process for managing the apparatus in real time. The data stored in the database system can be utilized as reference for subsequent inquiry, statistics, analysis and maintenance.

The database system is a relational database that comprises an apparatus table, a group table, a group monitor table, a single apparatus monitor table, a group monitor record table, and a single apparatus monitor record table. The apparatus table comprises a plurality of columns, including apparatus name, location, CPU (central processing unit) type, operating system, MAC (media access control) address, BIOS (basic input/output system) type, server type, hard disk type, IP (Internet Protocol) address, I/O (input/output) communication port, specification and description. The group table comprises a group name column and an apparatus name column, wherein the apparatus name column is associated with the apparatus name column of the apparatus table. The group monitor table comprises columns of group name, monitor item, setup value and warning signal, wherein the group name column is associated with the group name column of the group table. The single apparatus monitor table comprises columns of apparatus name, monitor item, setup value and warning signal, wherein the apparatus name column is associated with the apparatus name column of the apparatus table. The group monitor record table comprises a time column, a group name column and a monitor value column, wherein the group name column is associated with the group name column of the group monitor table. The single apparatus monitor record table comprises a time column, an apparatus name column and a monitor value column, wherein the apparatus name column is associated with the apparatus name column of the single apparatus monitor table. And, the management center stores apparatus data in corresponding tables.

The relational database further comprises a mail server table that includes columns of testing time, communication protocol, receiver mail address, sending time, sender, mail server receiving time, management center receiving time and receiver. And, the management center 2 stores data of a mail server in the mail server table.

The relational database further comprises an anti-virus server table that includes a time column, an apparatus name column and a virus definition version column. And, the management center 2 stores data of apparatuses managed by an anti-virus server in the anti-virus server table.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram showing connection of an automatic network management system of the invention to associated apparatuses;

FIG. 2 is a structure diagram of a database system of the invention;

FIG. 3 is a schematic diagram showing correlation between data tables of the database system of the invention;

FIG. 4 is a schematic table for a mail server of the invention; and

FIGS. 5 to 7 are schematic drawings showing operating interfaces of the invention.

### DETAILED DESCRIPTION OF THE PREFERRED EMBODIMENT

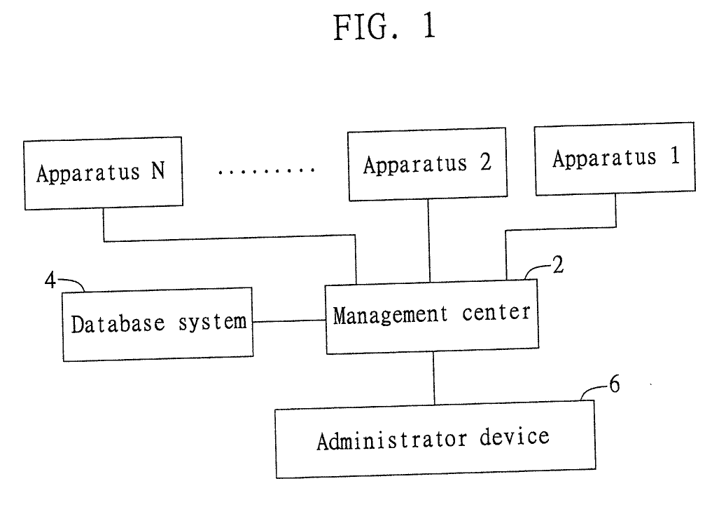

Referring to FIG. 1, an automatic network management system of the present invention comprises a management center 2 and a database system 4. The management center 2 at least comprises a computer host that is installed with manager software. The management center 2 is connected via a network to various apparatuses (apparatus 1 to apparatus N) such as a web phone, router, hub, mail server, anti-virus server and other types of servers; wherein, the network can be intranet or Internet. The database system 4 is installed in another computer host and connected to the management center 2 via a network; alternatively, the database system 4 can be established in the computer host of the management center 2. The management center 2 is further connected to an administrator device 6 via a network, and the administrator device 6 can be a computer host, cellular telephone, pager and personal digital assistant (PDA).

The manager software installed in the management center 2 would automatically read data via a network from each apparatus periodically, for example, at intervals of 10 minutes; wherein, data read by the management center 2 are stored in the database system 4. The database system 4 can be a relational database such as DB2, Oracle, Microsoft SQL (structured query language) and Sybase.

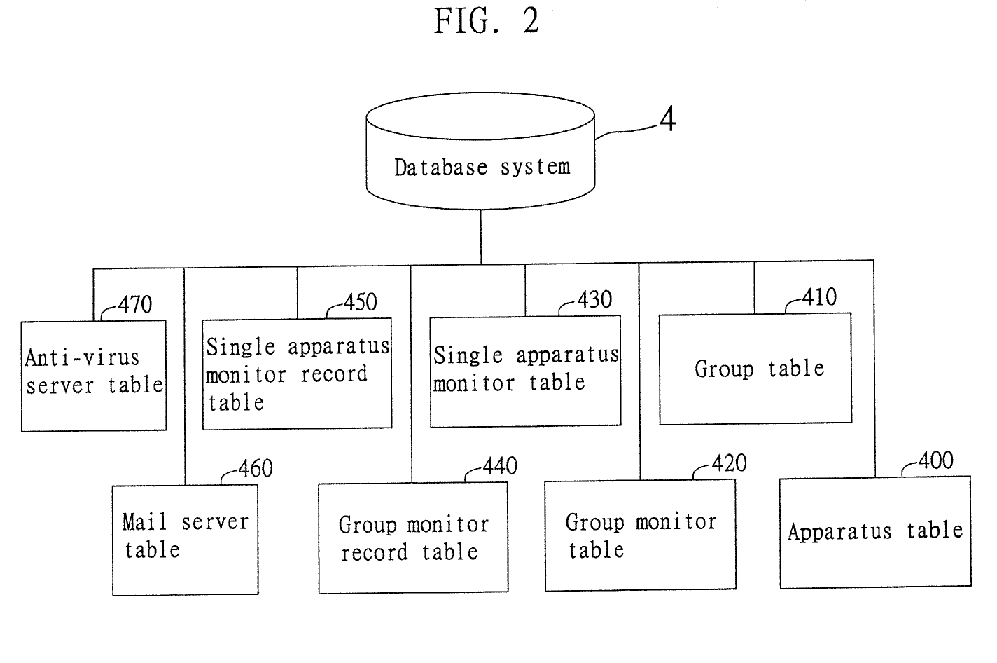

As shown in FIG. 2, the database system 4 comprises an apparatus table 400, a group table 410, a group monitor table 420, a single apparatus monitor table 430, a group monitor record table 440, a single apparatus monitor record table 450, a mail server table 460 and an anti-virus server table 470.

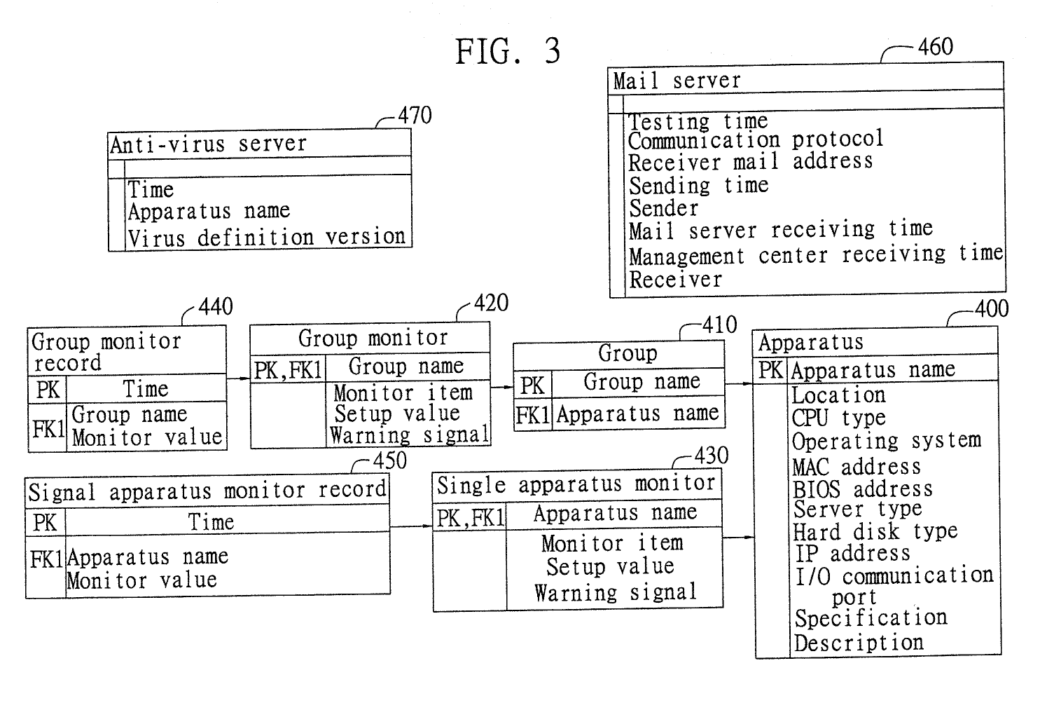

As shown in FIG. 3, the apparatus table 400 comprises a plurality of columns, including apparatus name, location, CPU (central processing unit) type, operating system, MAC (media access control) address, BIOS (basic input/output system) type, server type, hard disk type, IP (Internet Protocol) address, I/O (input/output) communication port, specification and description; wherein, the apparatus name column is set as a primary key column. The group table 410 comprises a group name column and an apparatus name column, wherein the group name column is set as a primary key column, and the apparatus name column of the group table 410 is associated with that of the apparatus table 400.

The group monitor table 420 comprises columns of group name, monitor item, setup value and warning signal. The group name column is set as a primary key column and associated with the group name column of the group table 410.

The single apparatus monitor table 430 comprises columns of apparatus name, monitor item, setup value and warning signal. The apparatus name column is set as a primary key column and associated with the apparatus name column of the apparatus table 400.

The group monitor record table 440 comprises a time column, a group name column and a monitor value column, wherein the group name column is set as a primary key column and associated with the group name column of the group monitor table 420. The single apparatus monitor record table 450 comprises a time column, an apparatus name column and a monitor value column, wherein the apparatus name column is set as a primary key column and associated with the apparatus name column of the single apparatus monitor table 430.

The mail server table 460 comprises columns of testing time, communication protocol, receiver mail address, sending time, sender, mail server receiving time, management center receiving time and receiver. The anti-virus server table 470 comprises a time column, an apparatus name column and a virus definition version column.

Data read by the management center 2 from each apparatus can be stored in a monitor value column of the group monitor record table 440 or single apparatus monitor record table 450 in accordance with time and group or apparatus name. An administrator can customarily set a value in a setup value column and define a warning signal in a warning signal column of the group monitor table 420 or single apparatus monitor table 430. By comparing a value in a monitor value column of the group monitor record table 440 to that in a setup value column of the group monitor table 420, if comparison result complies with a related rule defined by the manager software (for example, the value in the monitor value column is larger than that in the setup value column), the management center 2 would send a warning signal to the administrator device 6 to inform an administrator of malfunctioning of an associated group, or perform a maintenance control process (e.g. starting, stopping or restarting a related service program) for restoring the group to proper operation. Similarly, by comparing a value in a monitor value column of the single monitor record table 450 with that in a setup value column of the single apparatus monitor table 430, if comparison conforms to the related rule of the manager software, the management center 2 would send a warning signal to the administrator device 6 to inform the administrator of malfunctioning of an associated apparatus, or perform a maintenance control process (e.g. starting, stopping or restarting a related service program) to restore the apparatus to proper function. Further, content of the warning signal is defined in a warning signal column of the group monitor table 420 or single apparatus monitor table 430.

In the case of a remote access server (RAS) being managed by the management center 2, the management center 2 is capable of automatically logging in the remote access server periodically and testing if the remote access server works properly. In the meantime, a monitor item column of the group monitor table 420 or single apparatus monitor table 430 is a “login time” column, and a value stored in a monitor value column of the group monitor record table 440 or single apparatus monitor record table 450 indicates time spent for the management center 2 logging in the remote access server.

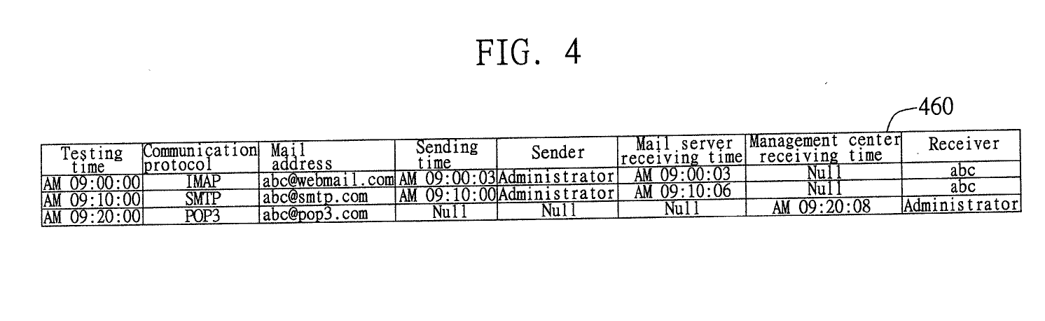

As shown in FIG. 4, in the case of a mail server being managed by the management center 2, the management center 2 is capable of automatically sending a test mail to the mail server periodically, and testing if an IMAP (Internet Message Access Protocol) service of the mail server functions normally, whereby associated data would be stored by the management center 2 in the mail server table 460 in accordance with testing time.

Moreover, the management center 2 would be able to automatically send a test mail to the mail server periodically, and then obtain the test mail from the mail server later, so as to test if a SMTP (Simple Mail Transfer Protocol) service and a POP3 (Post Office Protocol 3) service of the mail server operate properly.

As shown in FIG. 3, the management center 2 can be integrated with an anti-virus server, allowing the management center 2 to automatically read data from the anti-virus server periodically, and to store virus definition versions of apparatuses managed by the anti-virus server in accordance with time.

An operating interface of the manager software is herein of a window type to be conveniently operated by the administrator. Further, the manager software can be a web-based program, for allowing the administrator at any location to be linked to the management center 2 via Internet through the use of a browser in order to conduct apparatus management. Operation of the automatic network management system of the invention is involved in the following steps.

The first step is to connect an intended apparatus to the management center 2 of the invention via a network.

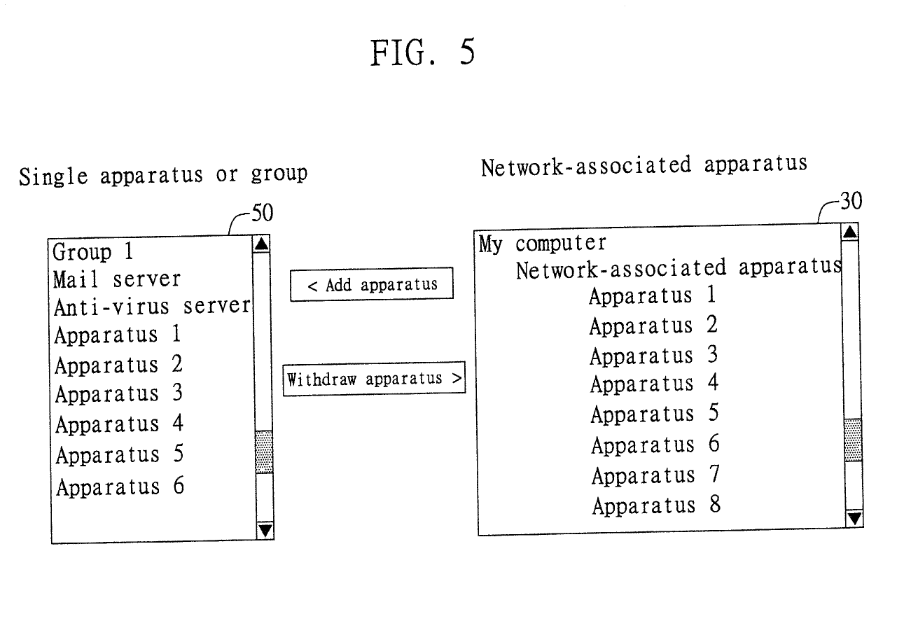

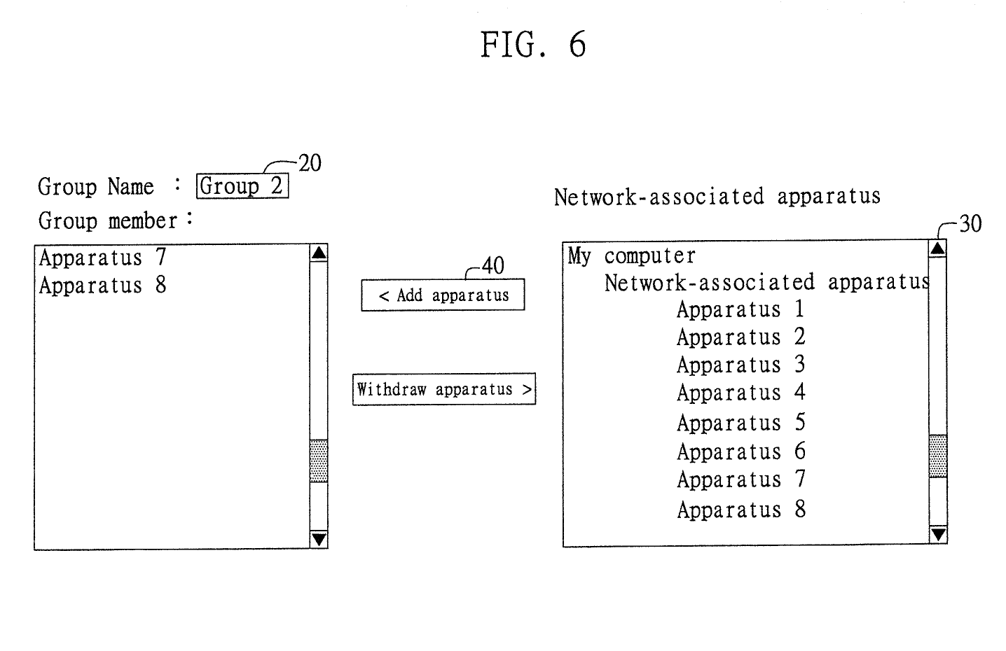

The next step is to add apparatus(es). For example, as shown in FIG. 5, the administrator can select an intended apparatus from a list box 30 of “network-associated apparatus”, and press a command button of “add apparatus” to add the selected apparatus into a list box 50 of “single apparatus or group”. Further, the administrator can also define a new group; as shown in FIG. 6, if the administrator defines a new group of “group 2”, and the group 2 is composed of an apparatus 7 and an apparatus 8 associated with the network, the administrator needs to input “group 2” in a text box 20, select the apparatuses 7, 8 from the list box 30, and then press a command button 40 of “add apparatus”, by which the selected apparatuses 7, 8 are added into a list box of“group member” pertained to the group 2; this then completes the process of adding apparatus(es).

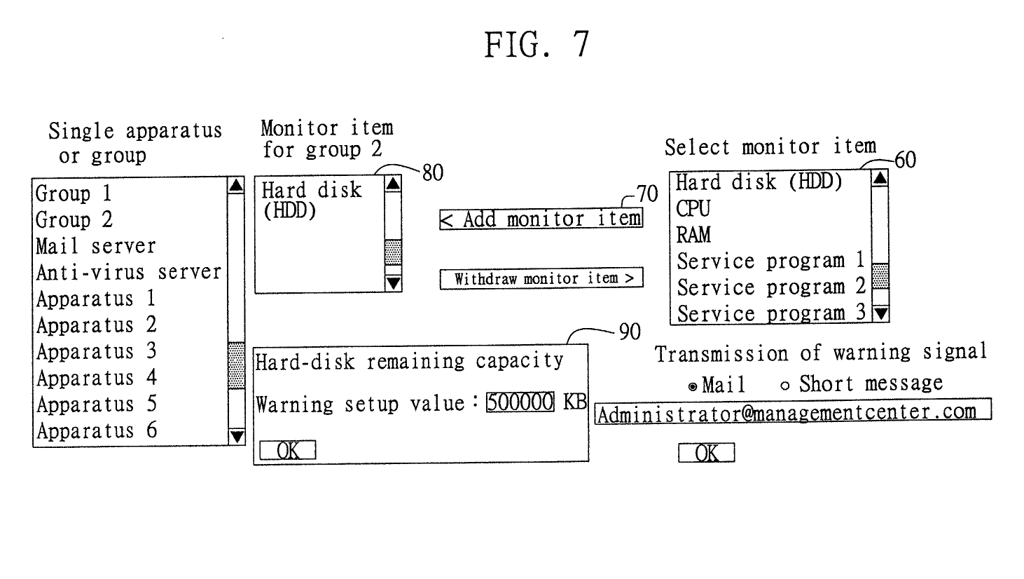

Then, it is to set up monitor content for a group or single apparatus. As shown in FIG. 7, if the administrator desires to set up monitor content for the group 2, he/she needs to select a “group 2” item in the list box 50, then select a monitor item (e.g. hard disk) from a list box 60 of “select monitor item”, and press a command button 70 of “add monitor item”, by which the selected monitor item (i.e. hard disk) is, added into a list box 80 of “monitor item for group 2”. After that, the administrator clicks on the “hard disk” item in the list box 80 to pop up a form 90, which allows the administrator to further customarily define related setup values for the hard disk (e.g. a warning value for hard-disk remaining capacity is set as 500000 KB). Therefore, when hard-disk remaining capacity of an apparatus (i.e. apparatus 7, 8) of the group 2 is smaller than 500000 KB, the management center 2 would send a warning signal to the administrator device 6 for informing the administrator to clean the apparatus. In addition, the warning signal can be forwarded by an electronic mail (e-mail) or short message; by e-mail transmission, the administrator needs to input an e-mail address thereof to a text box 100, e.g. Administrator@managementcenter.com.

The automatic network management system of the invention can provide significant advantages. First, a warning signal indicating malfunctioning of a group or apparatus would be automatically transferred to an administrator, allowing the administrator to promptly solve the malfunctioning problem. Moreover, each apparatus is automatically managed by the automatic network management system, making apparatus management more labor-effective to implement. And, apparatus data read by the automatic network management system can be stored in a database system, and the stored data include historical records of problems and solutions encountered for managed apparatuses, to be used as reference for subsequent inquiry, statistics, analysis and maintenance. In addition, the administrator at any location is allowed to be connected to the automatic network management system via a network through the use of a browser so as to conduct apparatus management.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An automatic network management system, comprising:
a management center at least comprising a host installed with manager software, the host being connected to at least an apparatus via a network, allowing the management center to automatically read data from the apparatus periodically, wherein the manager software is defined with management rules; and
a database system for storing data read by the management center, wherein the data are assessed with corresponding management rules by the management center, so as to determine whether to send a warming signal or to perform a maintenance control process so as to manage the apparatus in real time.

2. The automatic network management system of claim 1, wherein the apparatus is a remote access server (RAS), and the management center is capable of automatically logging in the remote access server periodically, so as to test if the remote access server functions properly.

3. The automatic network management system of claim 1, wherein the apparatus is a mail server.

4. The automatic network management system of claim 3, wherein the management center is capable of automatically sending a test mail to the mail server periodically, so as to test if an IMAP (Internet Message Access Protocol) service of the mail server functions properly.

5. The automatic network management system of claim 3, wherein the management center is capable of automatically sending a test mail to the mail server periodically, so as to test if a SMTP (Simple Mail Transfer Protocol) service of the mail server functions properly.

6. The automatic network management system of claim 5, wherein the management center is capable of obtaining the test mail from the mail server periodically, so as to test if a POP3 (Post Office Protocol 3) service of the mail server functions properly.

7. The automatic network management system of claim 1, wherein the apparatus is an anti-virus server, and the management center is capable of reading a virus definition version from the anti-virus server.

8. The automatic network management system of claim 1, wherein the database system is a relational database that at least comprises a table selected from a group consisting of an apparatus table, a group table, a group monitor table, a single apparatus monitor table, a group monitor record table and a single apparatus monitor record table.

9. The automatic network management system of claim 8, wherein the apparatus table at least comprises a column selected from a group consisting of an apparatus name column, a location column, a CPU (central processing unit) type column, an operating system column, a MAC (media access control) address column, a BIOS (basic input/output system) type column, a server type column, a hard disk type column, an IP (Internet Protocol) address column, an I/O (input/output) communication port column, a specification column and a description column.

10. The automatic network management system of claim 9, wherein the group table at least comprises a column selected from a group consisting of a group name column and an apparatus name column, and the apparatus name column is associated with the apparatus name column of the apparatus table.

11. The automatic network management system of claim 10, wherein the group monitor table at least comprises a column selected from a group consisting of a group name column, a monitor item column, a setup value column and a warning signal column, and the group name column is associated with the group name column of the group table.

12. The automatic network management system of claim 9, wherein the single apparatus monitor table at least comprises a column selected from a group consisting of an apparatus name column, a monitor item column, a setup value column and a warning signal column, and the apparatus name column is associated with the apparatus name column of the apparatus table.

13. The automatic network management system of claim 11, wherein the group monitor record table at least comprises a column selected from a group consisting of a time column, a group name column and a monitor value column, and the group name column is associated with the group name column of the group monitor table.

14. The automatic network management system of claim 12, wherein the single apparatus monitor record table at least comprises a column selected from a group consisting of a time column, an apparatus name column and a monitor value column, and the apparatus name column is associated with the apparatus name column of the single apparatus monitor table.

15. The automatic network management system of claim 13, wherein a value in the monitor value column of the group monitor record table is compared to that in the setup value column of the group monitor table, and if comparison result complies with a corresponding management rule of the manager software, the management center sends a warning signal to inform an administrator, or performs a maintenance control process to restore the apparatus to proper operation.

16. The automatic network management system of claim 14, wherein a value in the monitor value column of the single apparatus monitor record table is compared to that in the setup value column of the single apparatus monitor table, and if comparison result complies with a corresponding management rule of the manager software, the management center sends a warning signal to inform an administrator, or performs a maintenance control process to restore the apparatus to proper operation.

17. The automatic network management system of claim 3, wherein the database system is a relational database that at least comprises a mail server table, and the mail server table at least comprises a column selected from a group consisting of a testing time column, a communication protocol column, a receiver mail address column, a sending time column, a sender column, a mail server receiving time column, a management center receiving time column and a receiver column.

18. The automatic network management system of claim 7, wherein the database system is a relational database that at least comprises an anti-virus server table, and the anti-virus table at least comprises a column selected from a group consisting of a time column, an apparatus name column and a virus definition version column.

19. The automatic network management system of claim 1, wherein an administrator is connected to the management center via a browser so as to manage the apparatus.

20. The automatic network management system of claim 1, wherein the warning signal from the management center is sent via a network to an electronic device of an administrator, and the electronic device is one selected from a group consisting of a computer, a mobile phone, a pager and a personal digital assistant (PDA).
